(19) United States
(12) Patent Application Publication
(10) Pub. No.: US 2026/0063203 A1
(43) Pub. Date: Mar. 5, 2026

(54) PARK LOCK SYSTEM

(71) Applicant: DANA GRAZIANO S.R.L., Rivoli (IT)

(72) Inventor: Marco SILVESTRI, Rivoli (IT)

(21) Appl. No.: 19/283,053

(22) Filed: Jul. 28, 2025

Related U.S. Application Data
(60) Provisional application No. 63/688,653, filed on Aug. 29, 2024.

(51) Int. Cl. F16H 63/34

(52) U.S. Cl. CPC F16H 63/3466; F16H 63/3425

(57) ABSTRACT

A system with a park lock device. In one example, the park lock device includes an actuator shaft that includes a semi-circular cam interface with two lobes and a spring retention flange. The park lock device further includes a spring coupled to the spring retention flange and a cam that is mated with the cam interface.

### CROSS-REFERENCE TO RELATED APPLICATION

The present application claims priority to U.S. Provisional Application No. 63/688,653, entitled “PARK LOCK SYSTEM”, and filed on August 29, 2024. The entire contents of the above-listed application are hereby incorporated by reference for all purposes.

### TECHNICAL FIELD

The present disclosure relates to a park lock system. More particularly the present disclosure relates to a park lock system that reduces back-drive in a park lock device during device actuation.

### BACKGROUND AND SUMMARY

Vehicles include park lock mechanisms to prevent vehicle movement when the vehicle is stationary by engaging a park lock gear in the transmission. The inventors have recognized that some park lock mechanisms have previously exhibited back-drive torque as well as increased complexity due to the convoluted construction of the park lock mechanisms. The back-drive torques are loads generated by the kinetic energy of the pawl that is ratcheting and unable to engage in the vanes of the park gear due to the high speed of the park gear. These loads travel back through the mechanism’s kinematic chain and arrive at the actuator, thereby causing degradation or inoperability of the actuator, in some cases.

The inventors have recognized the abovementioned drawbacks of previous park lock systems and developed a park lock device to overcome at least a portion of the drawbacks. In one example, the park lock device includes an actuator shaft that has a semi-circular cam interface with two lobes and a spring retention flange. The park lock device further includes a spring coupled to the spring retention flange and a cam. The park lock device even further includes the cam that is mated with the cam interface. In this way, back-drive torque cause by pawl ratcheting is reduced, thereby increasing park lock device durability and longevity.

In one example, the actuator shaft may include two gearbox housing interfaces and the semi-circular cam interface and the spring retention flange are positioned axially between the two gearbox housing interfaces. In this way, the compactness of the park lock device is increased and the back-drive torque may be transferred to the housing which is more capable of receiving the increased load.

Further in one example, the park lock device includes a pawl that mates with the cam and a pawl shaft with an axial stopper formed therewith. The impact on the pawl during park lock engagement is transferred to the housing, thereby reducing the chance of component degradation.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a vehicle with an electric drive with a transmission and a park lock device.

FIGS. 2-4 show different views of an example of a park lock device.

FIG. 5 shows a detailed view of a park lock actuator that is included in the park lock device, depicted in FIGS. 2-4.

FIG. 6 shows another view of the park lock device, depicted in FIGS. 2-4.

FIGS. 7-8 show the park lock device, depicted in FIGS. 2-4, in different configurations.

FIG. 9 shows another view of the park lock device, depicted in FIGS. 2-4.

FIG. 10 shows a detailed view of an actuator shaft that is included in the park lock device, depicted in FIGS. 2-4.

FIG. 11 shows a detailed view of a pawl shaft that is included in the park lock device, depicted in FIGS. 2-4.

FIG. 12 shows a method for operation of a park lock device.

### DETAILED DESCRIPTION

A park lock device is described herein that is designed to reduced back-drive torque during device ratcheting where the pawl is attempting to engage the parking gear but unable to engage due to the speed of the parking gear. To achieve the reduced back-drive torque, the park lock device includes an actuator shaft with a semi-circular cam interface with two lobes and a spring retention flange.

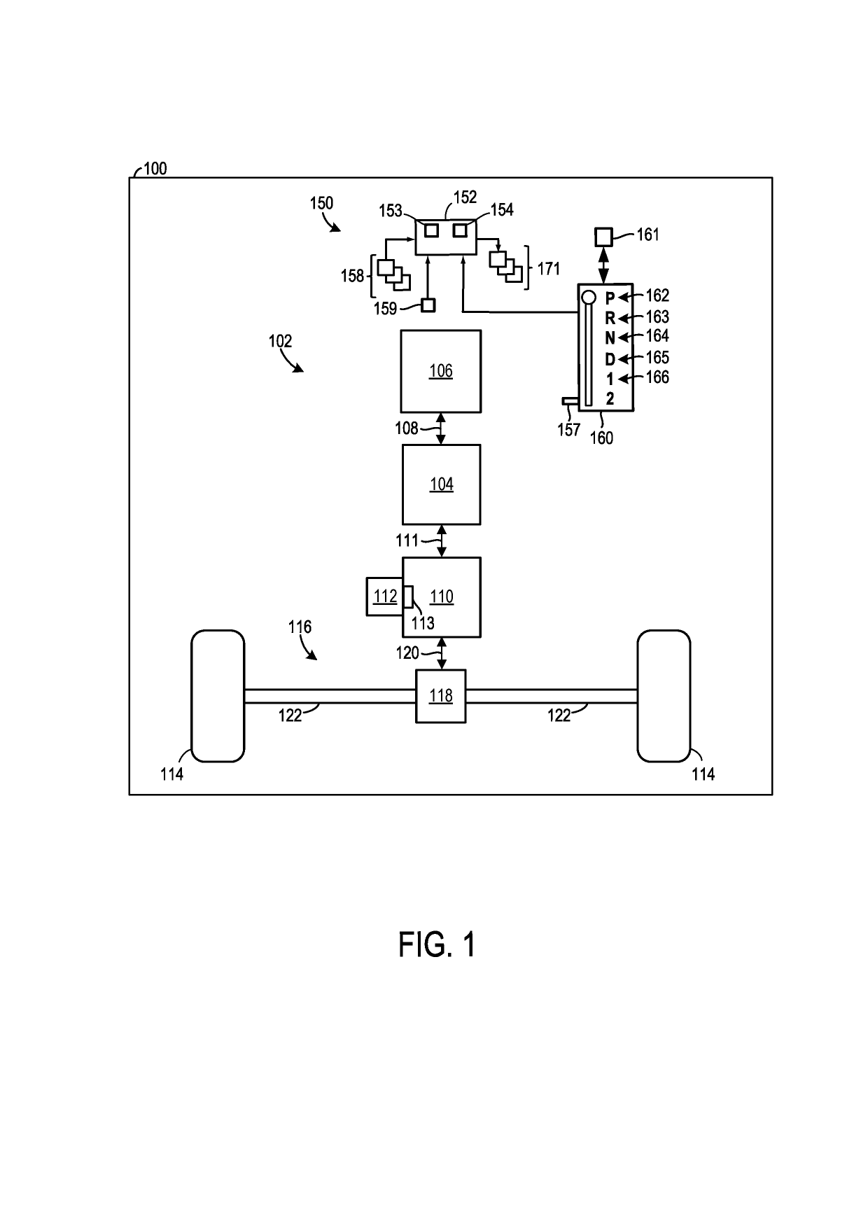

FIG. 1 depicts a vehicle 100 with a powertrain 102 (e.g., an electric drive). As such, the vehicle 100 may be an electric vehicle (EV) or an internal combustion engine (ICE) vehicle, in different examples. In one example, the vehicle may be an all-electric vehicle due to its reduced complexity and therefore reduced points of potential component degradation when compared to vehicles with internal combustion engines. For instance, the electric drive unit may be an electric axle or include a traction motor that provide power to transmission which in turn provides power to a drive axle. However, in other example, the vehicle 100 may be a hybrid electric vehicle (HEV) where the vehicle includes an internal combustion engine (ICE) along with the electric drive unit. For instance, the electric drive unit may provide power to one axle while the ICE provides power to another axle or the ICE may be configured to recharge the traction battery or other suitable energy storage device for range extension. Further, the vehicle 100 may be a light, medium, or heavy duty vehicle.

The powertrain 102, in the electric drive example, may include an electric machine 104 (e.g., an electric motor or motor-generator such as a multi-phase alternating current (AC) motor-generator, although numerous types of electric machines have been contemplated) and an energy storage device 106 (e.g., a battery such as a traction battery), capacitor, combinations thereof, and the like). Arrows 108 depict the transfer of electrical energy between the energy storage device 106 and the electric machine 104. However, in other examples, an ICE may be used instead of the traction motor and the traction battery.

When the electric machine 104 is an AC machine, the electric drive may include an inverter that converts direct current (DC) from the energy storage device 106 into AC for the electric machine and vice versa.

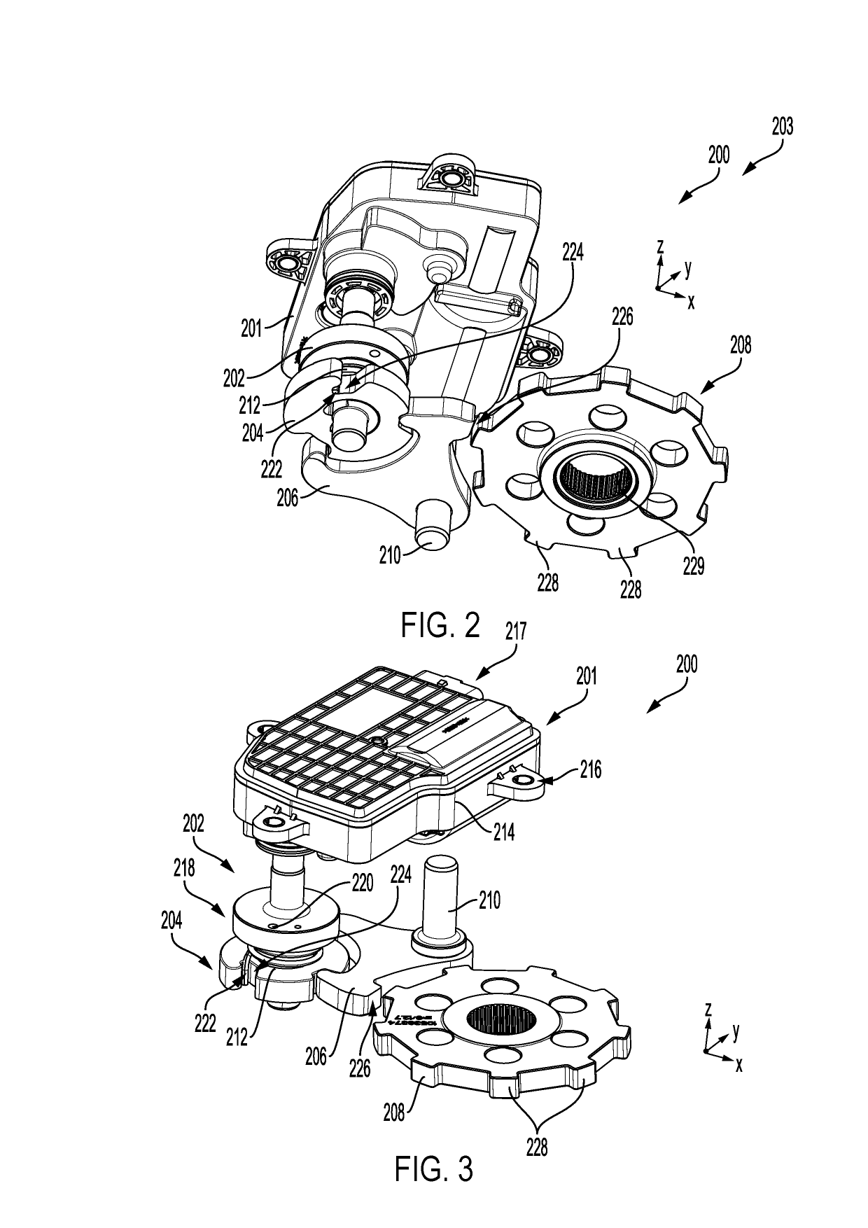

The powertrain 102 may include a transmission 110 (e.g., a multi-speed gearbox) that is coupled to the electric machine 104 or other suitable prime mover such as an internal combustion engine. Specifically, arrows 111 denote the transfer of mechanical power between the electric machine 104 and the transmission 110. Said power transfer may be implemented via shafts, gears, chains, rotational couplings, combinations thereof, and the like. The transmission 110 may include gears, clutches, shafts, and the like to achieve the multi-speed functionality. The park lock device 112 may be mechanically attached (e.g., bolted, clamped, combinations thereof, and the like) to the transmission 110. The park lock device is configured to selectively inhibit rotation of a park lock gear 113 (which is schematically depicted in the example illustrated in FIG. 1) in the transmission, thereby inhibiting vehicle movement. As such, the park lock device 112 may be included in the transmission 110. The park lock device 112 is schematically illustrated in FIG. 1. However, the park lock device 112 has greater structural and functional complexity that is expanded upon herein with regard to FIGS. 2-11.

The transmission 110 may be coupled to one or more drive wheels 114 via an axle 116 that may include a differential 118, for example. However, a variety of axle configurations have been contemplated. Arrows 120 specifically denote the transfer of mechanical power between the transmission 110 and the axle 116 (e.g., the differential 118). Axle shafts 122 may be coupled to the drive wheels 114 and the differential 118. The electric drive may be an electric axle, in one embodiment. Electric axles can provide a highly adaptable and space efficient drive unit package. However, in other examples, the electric drive may include a transmission and electric motor that are spaced away from the axle assembly.

The vehicle 100 may further include a control system 150 with a controller 152 as shown in FIG. 1. The controller 152 may include a microcomputer with components such as a processor 154 (e.g., a microprocessor unit), input/output ports, an electronic storage medium 153 for executable programs and calibration values, e.g., a read-only memory chip, random access memory, keep alive memory, a data bus, and the like. The storage medium may be programmed with computer readable data representing instructions executable by a processor for performing the methods and control techniques described herein as well as other variants that are anticipated but not specifically listed.

The controller 152 may receive various signals from sensors 158 coupled to various regions of vehicle 100. For example, the sensors 158 may include an electric machine speed sensor, a pedal position sensor to detect a depression of an operator-actuated pedal, such as an accelerator pedal or a brake pedal, speed sensors at the wheels 114, a shift device position sensor 157, and the like. An input device 159 (e.g., an accelerator pedal, a brake pedal, combinations thereof, and the like) may further provide input signals indicative of an operator’s intent for vehicle acceleration and braking.

A shift device 160 (e.g., gear selector) may further be included in the electric drive. The shift device 160 may include a park position 162. It will be understood that the movement of the shift device into the park position may be sensed by the controller and in response to detecting this movement, the controller may send a control command to the park lock device to initiate park lock engagement and vice versa. The shift device 160 may further include a reverse position 163, a neutral position 164, a drive position 165, and/or one or more gear position 166 (e.g., a first gear position, a second gear position, etc.). Responsive to an operator (schematically depicted at 161) placing the shift device 160 into the park position 162 the park lock device 112 may be placed in an engaged configuration. Conversely, responsive to the operator moving the shift device out of the park position into one of the other available positions, the park lock device may be placed in a disengaged configuration. Thus, the park lock device may be unlocked when the gear selector is shifted into drive, reverse, or neutral and locked when the gear selector is shifted into park.

The shift device 160 and components in the transmission such as the park lock device, clutches, and the like may be in electronic communication with the controller 152. Thus, in such an example, the park lock device and clutches may be engaged and disengaged via electronic command signals from the controller 152. However, in other examples, at least a portion of the components in the transmission may be mechanically coupled to the shift device. Furthermore, in the shift-by-wire embodiment, the park lock device may be configured for operator induced disengagement as well as electronic engagement and disengagement.

Upon receiving the signals from the various sensors 158 of FIG. 1, the controller 152 processes the received signals, and employs various actuators 171 of vehicle components to adjust the components based on the received signals and instructions stored on the memory of controller 152. For example, the controller 152 may receive an accelerator pedal signal indicative of an operator request for increased vehicle acceleration. In response, the controller 152 may command operation of the electric machine 104 to adjust actuators in the electric machine to alter machine power output to increase the power delivered from the machine to the drive wheels via the transmission. Further, the controller may receive a signal from the shift device 160 indicative of movement of the device into the park positon. Responsive to receiving this signal, the controller may send a command to the park lock device to place it in an engaged configuration that inhibits vehicle motion. The other controllable components in the vehicle may function in a similar manner with regard to sensor signals, control commands, and actuator adjustment, for example.

An axis system is provided in FIG. 1 as well as FIGS. 2-11, for reference, when appropriate. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

FIGS. 2 and 3 show a park lock device 200 in a park lock system 203. The park lock device 200 serves as an example of the park lock device 112 depicted in FIG. 1. As such, the park lock device 200 may be included in the powertrain 102 (e.g., electric drive) and/or share common structural and/or functional features with the park lock device 112 depicted in FIG. 1 and/or vice versa. To elaborate, the park lock device 200 may be included in the transmission 110, shown in FIG. 1.

The park lock device 200 in the example illustrated in FIG. 2 includes a smart actuator 201, an actuator shaft 202, a cam 204, a pawl 206, a park gear 208, a pawl shaft 210, and a spring 212. The smart actuator 201 includes a motor 211 and/or other mechanisms configured to rotate the actuator shaft 202. Further, the smart actuator 201 may be designed to forego the use of an external position sensor and external magnet lever. As such, the park lock device 200 may not include a position sensor and a magnet lever that are external to the smart actuator 201. Therefore, in such an example, the motor 211 may include a rotational sensor incorporated therein that senses the rotational angle of the actuator shaft 202. The smart actuator 201 includes a housing 214 with mounting interfaces 216 in the illustrated example. An electrical interface 217 of the smart actuator 201 is additional depicted in FIGS. 2-3.

The actuator shaft 202 includes a spring retention flange 218 with a spring opening 220, in the illustrated example. The spring opening 220 is profiled to receive an end of the spring 212. Another end 222 of the spring 212 mates with a recess 224 in the cam 204.

The pawl 206 includes a protrusion 226 that mates with the park gear 208 and prevents rotation thereof in an engaged position. The park gear 208 includes teeth 228 to enable this functionality. Conversely, when the park lock device 200 is in the disengaged configuration, the protrusion 226 disengages from the park gear 208. It will be understood that FIGS. 2-3 show the park lock device 200 in the disengaged configuration. The park gear 208 includes splines 229 for attaching to a shaft in the transmission, in the illustrated example.

A lobe 230 of the cam 204 mates with a recess 232 of the pawl 206. Prongs 234 of the pawl 206 rotationally delimit the lobe 230. A gap 236 may be formed between the actuator shaft 203 and the cam 204. Further, the actuator shaft 202 is parallel to the pawl shaft 210 in the illustrated example. In this way, the space efficiency of the device is increased. However, other relative shaft orientations are possible.

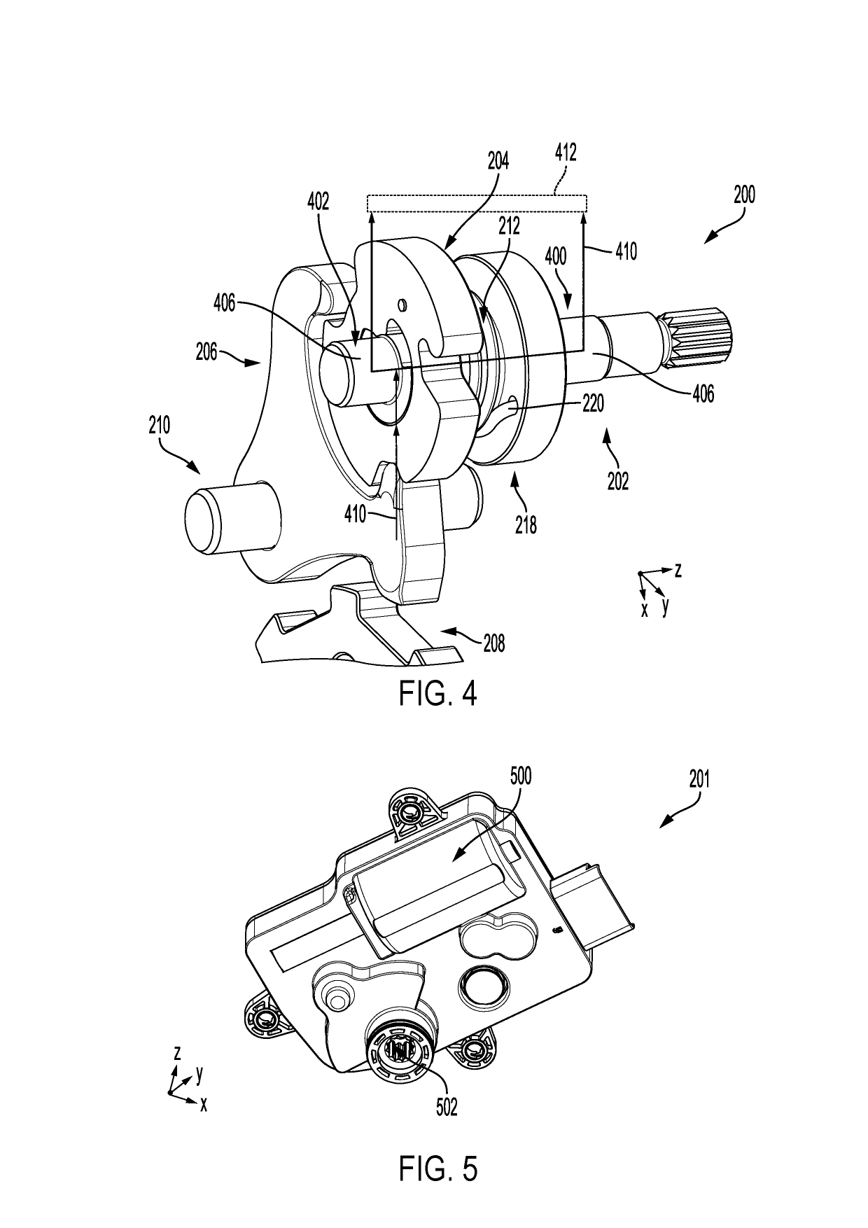

FIG. 4 shows another view of the park lock device 200. The actuator shaft 202, the cam 204, the pawl 206, the park gear 208, the pawl shaft 210, and the spring 212 are again illustrated. As shown, the spring 212 mates with the spring opening 220 in the actuator shaft 202. The actuator shaft 202 includes two gearbox housing interfaces 400 and 402 that are positioned axially outboard of the spring retention flange 218 and the cam 204, respectively. In this way, the park lock device 200 is designed for efficient space integration and sealing in the gearbox. The gearbox housing interfaces 400 and 402 may have a cylindrical shape and surfaces 406 that are in face sharing contact with the gearbox housing.

Arrows 410 indicate the general back-drive load path that travels to the gearbox housing 412, which is schematically depicted in FIG. 4. It will be understood that the park lock device has less back-drive load than previous park lock mechanisms and the load is transferred to a component (i.e., the gearbox housing) that is able to handle the load with a decreased chance of degradation. In this way, the durability and longevity of the park lock device is increased.

FIG. 5 shows a detailed view of the smart actuator 201 that includes a motor 500 and an actuator shaft interface 502. The motor 500 may be perpendicularly arranged with regard to a vertical axis that is parallel to the rotational shaft of the actuator shaft. In this way, the park lock system is able to achieve a desired space efficiency.

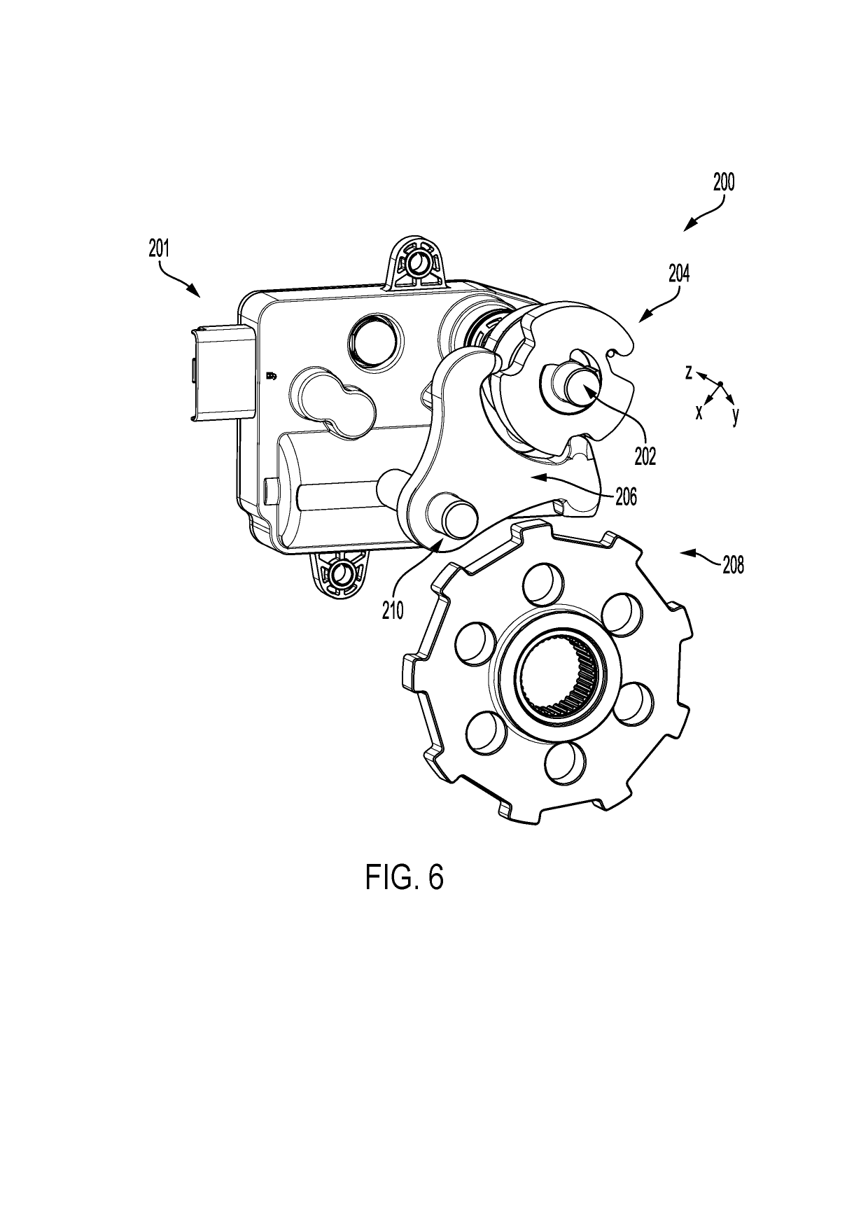

FIG. 6 shows another view of the park lock device 200. The smart actuator 201, the actuator shaft 202, the cam 204, the pawl 206, the park gear 208, the pawl shaft 210, and the spring 212 are again illustrated.

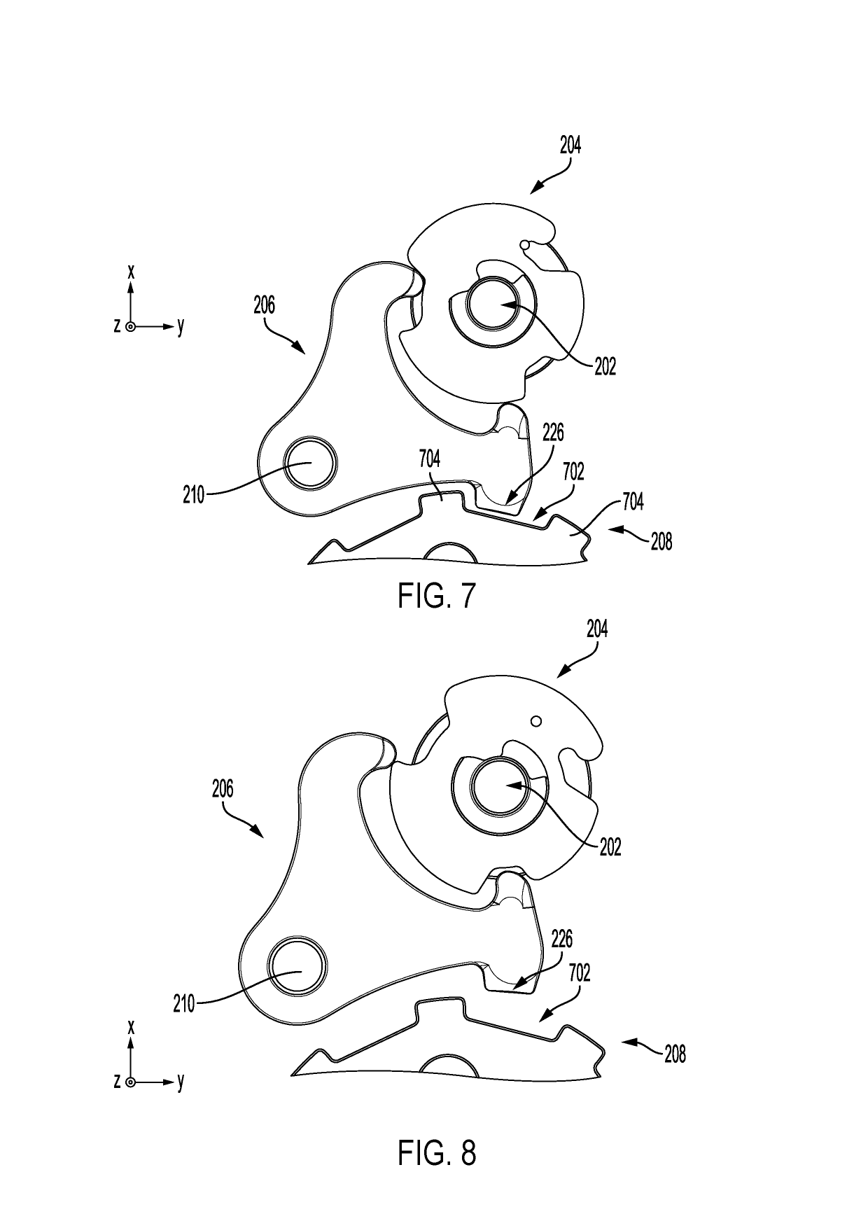

FIGS. 7-8 show the park lock device 200 in an engaged configuration and a disengaged configuration, respectively. In the engaged configuration, shown in FIG. 7, the protrusion 226 of the pawl 206 mates with a vane 702 between teeth 704 in the park gear 208. Rotation of the cam 204 induces movement of the pawl 206 into engagement. Conversely, FIG. 8 shows the protrusion 226 disengaged from the vane 702.

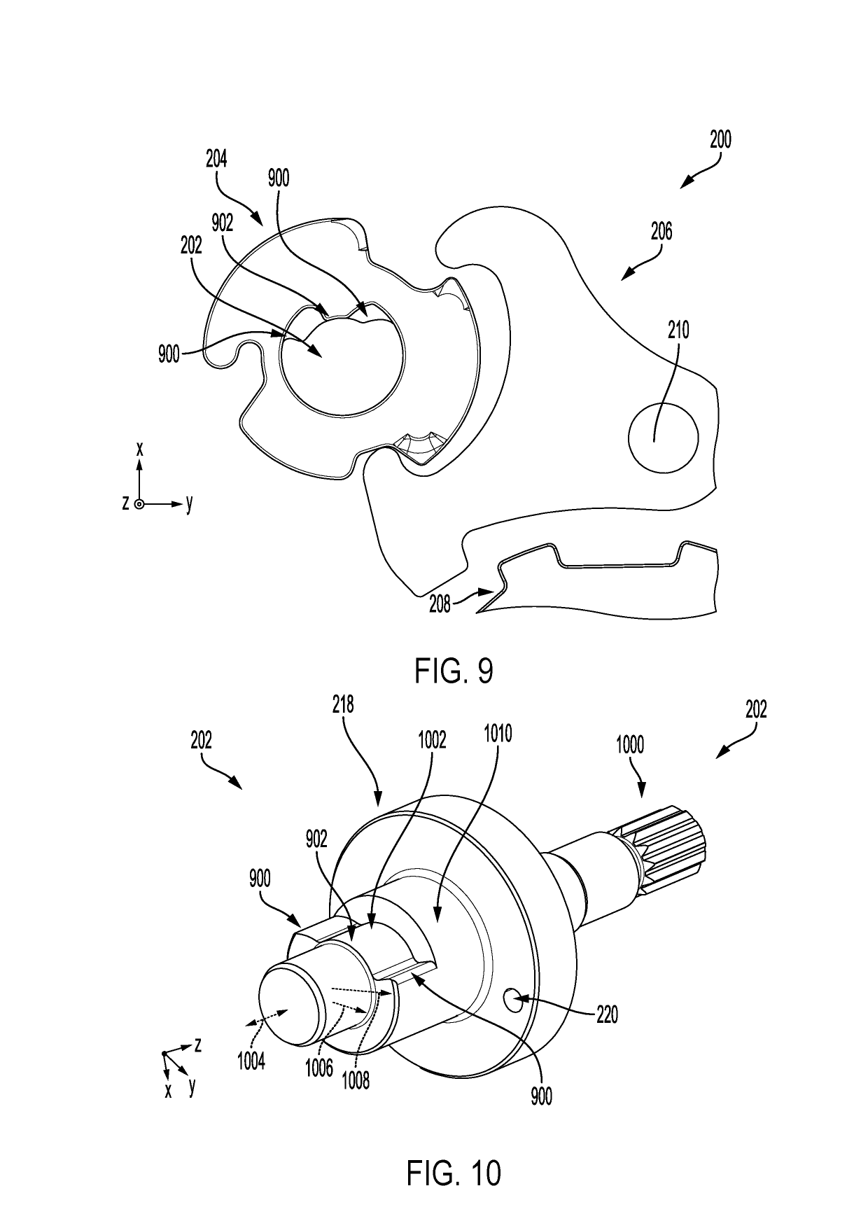

FIG. 9 shows another view of the park lock device 200. The actuator shaft 202, the cam 204, the pawl 206, the park gear 208, the pawl shaft 210, and the spring 212 are again illustrated. Two lobes 900 in a cam interface 902 of the actuator shaft 202 are depicted. The lobes 900 enable the back-drive occurring in the park drive device to be reduced.

FIG. 10 shows a detailed view of the actuator shaft 202. An actuator interface 1000 (e.g., a splined interface) is depicted along with the cam interface 902 that includes the lobes 900 are depicted. To elaborate, the actuator interface 1000 includes a semi-circular section 1002 with the cam interface 902 between the lobes 900. The spring retention flange 218 with the spring opening 220 is further depicted in FIG. 10. A rotational axis 1004 of the actuator shaft 202 is provided for reference. The actuator shaft 202 includes an inner radius 1006 and an outer radius 1008, in the illustrated example. A section 1010 of the actuator shaft 202 has a constant outer diameter that functions to axially delimit the cam, when the cam is mated with the actuator shaft. The spring opening 220 and the other spring opening described herein may be parallel to the rotational axis 1004 of the actuator shaft 202.

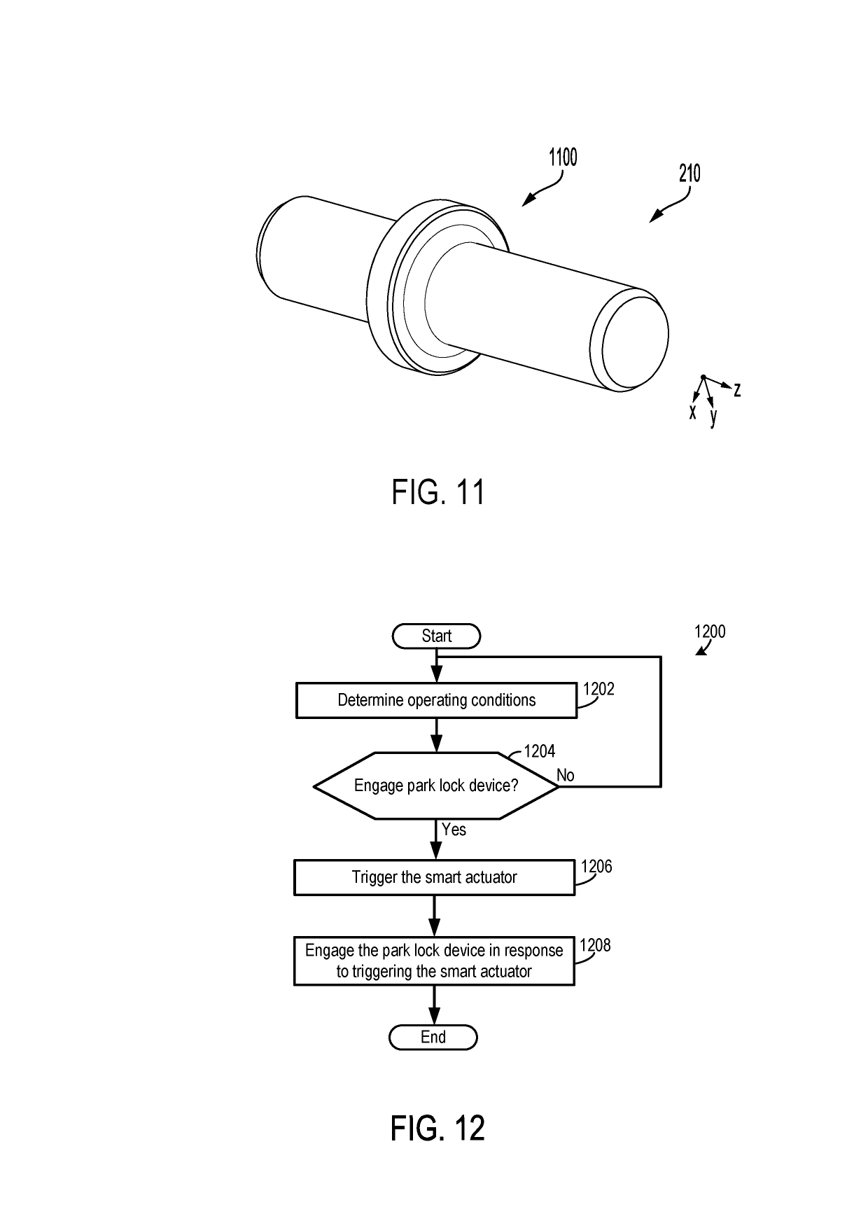

FIG. 11 shows a detailed view of the pawl shaft 210 with an axial stopper 1100 formed therewith. The axial stopper functions to simplify assembly and allows the shaft to be efficiently mated with the pawl 206 in a desired manner during device assembly.

FIG. 12 shows a method 1200 for operation of a park lock device. The method 1200 may be carried out by any of the park lock devices and systems more generally or combinations of the park lock devices and/or systems described herein with regard to FIGS. 1-11. However, the method 1200 may be carried via other suitable systems, in other examples. Furthermore, the method 1200 may be implemented as instructions stored in memory (e.g., non-transitory memory) of the controller that is executable by a processor.

At 1202, the method includes determining operating conditions. The operating conditions may include park lock device position, shift device position, prime mover speed (e.g., traction motor speed), driveline output speed, transmission output speed, wheel speed, vehicle speed, and the like. The operating conditions may be ascertained via sensor inputs, modeling, look-up tables, and/or other suitable techniques. Specifically, in one example, determining operating conditions may include sending data indicative of cam position in the park lock device from a smart actuator to a controller. As such, the smart actuator may include a device configured to sense the angular position of the actuation shaft.

At 1204, the method includes determining if the park lock device should be engaged. For instance, it may be determined if an operator has interacted with an input device (e.g., gear selector device) to initiate park lock device engagement. For example, a sensor in the gear selector may send data to the controller indicative of an operator’s desire to engage park lock.

If it is determined that the park lock device should not be engaged (NO at 1204) the method returns to 1202. Conversely, if it is determined that the park lock device should be engaged (YES at 1204) the method moves to 1206. At 1206, the method includes triggering the smart actuator via a controller command. Step 1206 may specifically include energizing a motor in the smart actuator to rotate an actuation shaft. At 1208, the method includes engaging the park lock device in response to triggering the smart actuator. Method 1200 allows the park lock device to be engaged with a reduced amount of back-drive torque, thereby increasing device longevity.

FIGS. 2-11 are drawn approximately to scale, aside from the schematically depicted components. However, other relative component dimensions may be used, in alternate embodiments.

FIGS. 1-11 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Elements parallel, perpendicular, or angled with regard to one another may be referred to as such.

The invention will be further described in the following paragraphs. In one aspect, a park lock device is provided that comprises an actuator shaft including: a semi-circular cam interface with two lobes; and a spring retention flange; a spring coupled to the spring retention flange and the cam; and a cam mated with the cam interface. In one example, the actuator shaft may include two gearbox housing interfaces and the cam interface and the spring retention flange are positioned axially between the two gearbox housing interfaces. In another example, the park lock device may further comprise a pawl shaft with an axial stopper formed therewith. In yet another example, the park lock device may further comprise a smart actuator rotationally coupled to the actuator shaft. In another example, the smart actuator may be configured to send data to a controller that is indicative of a rotational positon of the cam. In another example, the park lock device may be included in an electric drive.

In another aspect, a park lock device in an electric drive is provided that comprises a smart actuator directly rotationally coupled to an actuator shaft that includes: a semi-circular cam interface with two lobes; and a spring retention flange; a coil spring coupled to the spring retention flange and the cam; and a cam mated with the cam interface; wherein the coil spring is axially captured between the cam and the spring retention flange. In one example, the actuator shaft may include two gearbox housing interfaces and the cam interface and the spring retention flange are positioned axially between the two gearbox housing interfaces. In another example, the park lock device may further comprise a pawl shaft with an axial stopper formed therewith. In yet another example, the park lock device may not include a position sensor that is external to the smart actuator.

In another aspect, a park lock device is provided that comprises an actuator shaft including: a semi-circular cam interface with two lobes; and a spring retention flange; a spring coupled to the spring retention flange and a cam; and the cam mated with the semi-circular cam interface. In one example, the actuator shaft may include two gearbox housing interfaces and the semi-circular cam interface and the spring retention flange are positioned axially between the two gearbox housing interfaces. In another example, the park lock device may further comprise a pawl that mates with the cam. In another example, the park lock device may further comprise a pawl shaft with an axial stopper formed therewith. In yet another example, the pawl shaft may be parallel to the actuator shaft. In another example, the park lock device may further comprise a smart actuator rotationally coupled to the actuator shaft. In another example, the smart actuator may be configured to send data to a controller that is indicative of a rotational positon of the cam. In another example, the park lock device may be included in an electric drive.

In another aspect, a method for operation of a park lock device is provided that comprises triggering an actuator in the park lock device; and engaging the park lock device in response to triggering the actuator; wherein the park lock device includes: the actuator; an actuator shaft including: a semi-circular cam interface with two lobes; and a spring retention flange; a spring coupled to the spring retention flange and a cam; and the cam mated with the semi-circular cam interface. In one example, the actuator may include an electric motor. In yet another example, triggering the actuator may include energizing the electric motor. In one example, the method may further comprise sending data indicative of a position of the cam from the actuator to a controller. In another example, the method may further comprise a pawl that mates with the cam; and a pawl shaft coupled to the pawl and including an axial stopper formed therewith. In another example, the actuator shaft may include two gearbox housing interfaces and the semi-circular cam interface and the spring retention flange are positioned axially between the two gearbox housing interfaces. In another example, the pawl shaft may be parallel to the actuator shaft.

In another aspect, a park lock device in an electric drive is provided that comprises a smart actuator directly rotationally coupled to an actuator shaft that includes: a semi-circular cam interface with two lobes; and a spring retention flange; a coil spring coupled to the spring retention flange and a cam; and the cam mated with the semi-circular cam interface; wherein the coil spring is axially captured between the cam and the spring retention flange. In one example, the actuator shaft may include two gearbox housing interfaces and the semi-circular cam interface and the spring retention flange are positioned axially between the two gearbox housing interfaces. In another example, the park lock device may further comprise a pawl that mates with the cam; and a pawl shaft coupled to the pawl and including an axial stopper formed therewith. In another example, the park lock device may not include a position sensor that is external to the smart actuator. In another example, the pawl shaft may be parallel to the actuator shaft.

Note that the example control and estimation routines included herein can be used with various powertrain, electric drive, and/or vehicle system configurations. The control methods and routines disclosed herein may be stored as executable instructions in non-transitory memory and may be carried out by the control system including the controller in combination with the various sensors, actuators, and other transmission and/or vehicle hardware in combination with the electronic controller. As such, the described actions, operations, and/or functions may graphically represent code to be programmed into non-transitory memory of the computer readable storage medium in the electric drive unit and/or vehicle system. The various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range, unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A park lock device, comprising:
an actuator shaft including:
a semi-circular cam interface with two lobes; and
a spring retention flange;
a spring coupled to the spring retention flange and a cam; and
the cam mated with the semi-circular cam interface.

2. The park lock device of claim 1, wherein the actuator shaft includes two gearbox housing interfaces and the semi-circular cam interface and the spring retention flange are positioned axially between the two gearbox housing interfaces.

3. The park lock device of claim 1, further comprising a pawl that mates with the cam.

4. The park lock device of claim 3, further comprising a pawl shaft with an axial stopper formed therewith.

5. The park lock device of claim 4, wherein the pawl shaft is parallel to the actuator shaft.

6. The park lock device of claim 1, further comprising a smart actuator rotationally coupled to the actuator shaft.

7. The park lock device of claim 6, wherein the smart actuator is configured to send data to a controller that is indicative of a rotational positon of the cam.

8. The park lock device of claim 1, wherein the park lock device is included in an electric drive.

9. A method for operation of a park lock device, comprising:
triggering an actuator in the park lock device; and
engaging the park lock device in response to triggering the actuator;
wherein the park lock device includes:
the actuator;
an actuator shaft including:
a semi-circular cam interface with two lobes; and
a spring retention flange;
a spring coupled to the spring retention flange and a cam; and
the cam mated with the semi-circular cam interface.

10. The method of claim 9, wherein the actuator includes an electric motor.

11. The method of claim 10, wherein triggering the actuator includes energizing the electric motor.

12. The method of claim 9, further comprising sending data indicative of a position of the cam from the actuator to a controller.

13. The method of claim 9, further comprising:
a pawl that mates with the cam; and
a pawl shaft coupled to the pawl and including an axial stopper formed therewith.

14. The method of claim 13, wherein the actuator shaft includes two gearbox housing interfaces and the semi-circular cam interface and the spring retention flange are positioned axially between the two gearbox housing interfaces.

15. The method of claim 14, wherein the pawl shaft is parallel to the actuator shaft.

16. A park lock device in an electric drive, comprising:
a smart actuator directly rotationally coupled to an actuator shaft that includes:
a semi-circular cam interface with two lobes; and
a spring retention flange;
a coil spring coupled to the spring retention flange and a cam; and
the cam mated with the semi-circular cam interface;
wherein the coil spring is axially captured between the cam and the spring retention flange.

17. The park lock device of claim 16, wherein the actuator shaft includes two gearbox housing interfaces and the semi-circular cam interface and the spring retention flange are positioned axially between the two gearbox housing interfaces.

18. The park lock device of claim 16, further comprising:
a pawl that mates with the cam; and
a pawl shaft coupled to the pawl and including an axial stopper formed therewith.

19. The park lock device of claim 16, wherein the park lock device does not include a position sensor that is external to the smart actuator.

20. The park lock device of claim 18, wherein the pawl shaft is parallel to the actuator shaft.
